(19) United States
(12) Patent Application Publication
(10) Pub. No.: US 2008/0307813 A1
(43) Pub. Date: Dec. 18, 2008

(54) Variable Capacity Multiple Circuit Air Conditioning System

(75) Inventors: Alexander Lifson, Manlius, NY (US); Michael F. Taras, Fayetteville, NY (US)

Correspondence Address: MARJAMA MULDOON BLASIAK & SULLIVAN LLP, 250 SOUTH CLINTON STREET, SUITE 300, SYRACUSE, NY, 13202, US

(73) Assignee: CARRIER CORPORATION, Farmington, CT (US)

(21) Appl. No.: 12/096,243

(22) PCT Filed: Dec. 21, 2005
(86) PCT No.: PCT/US2005/046716

§ 371 Date: Jun. 5, 2008

(51) Int. Cl. F25B 1/00; F25B 7/00; F01C 1/02; G05B 15/00

(52) U.S. Cl. 62/228.4; 62/498; 62/510; 418/55.1; 700/275

(57) ABSTRACT

A refrigerant vapor compression system for conditioning air within a climate controlled space has multiple refrigerant circuits including at least one refrigerant circuit having a fixed capacity and at least one refrigerant circuit having a variable capacity. Each refrigerant circuit includes a compressor, a condenser, an expansion device and an evaporator connected in refrigerant circulation flow communication. The compressor associated with each fixed capacity refrigerant circuit is a fixed speed compressor and the compressor associated with each variable capacity refrigerant circuit is a variable speed compressor. A controller is provided for controlling the speed of the variable speed compressor to adjust the refrigeration capacity of the variable capacity refrigerant circuit and thereby adjust the overall capacity of the system to match the cooling demands.

### FIELD OF THE INVENTION

This invention relates generally to multi-circuit air conditioning, heat pump or refrigeration systems and, more particularly, to multi-circuit air conditioning, heat pump or refrigeration systems having variable capacity capability.

### BACKGROUND OF THE INVENTION

Refrigerant vapor compression systems are well known in the art and commonly used for cooling and generally dehumidifying air supplied to a climate controlled comfort zone within an office building, hospital, school, restaurant or other commercial facility. These systems normally constitute a refrigerant circuit including a compressor, a condenser, an expansion device, and an evaporator connected by refrigerant lines in a closed refrigerant circuit in refrigerant flow communication and arranged in accord with known refrigerant vapor compression cycle schematics. An expansion device, commonly an expansion valve, is disposed in the refrigerant circuit upstream, with respect to refrigerant flow, of the evaporator and downstream of the condenser. In operation, a fan associated with an evaporator circulates air to be conditioned from a climate controlled environment and passes that indoor air, often mixed with an outside fresh air in various proportions, through the evaporator. As the air flows over evaporator, the air interacts, in a heat exchange relationship, with refrigerant passing through the heat exchanger, typically, inside tubes or channels. As a result, in the cooling mode of operation, the air is cooled, and generally dehumidified.

It is a common practice for air conditioning systems for providing conditioned air to large spaces, such as in office buildings, hospitals, schools, restaurants or other commercial establishments, to include multiple, independent refrigerant circuits, rather the a single refrigerant circuit, to provide sufficient capacity to meet the required cooling demands. Multiple refrigerant circuit systems provide a certain degree of flexibility in capacity adjustment as well. For example, a multi-circuit refrigerant system might be provided with an additional circuit (or circuits) to provide a degree of overcapacity with respect to the normal cooling demand for a building. At times of normal cooling demand, one or more refrigerant circuits might be shut down with the remaining circuits having sufficient capacity to meet the cooling demand. When needed, such as on particularly hot and humid days, the additional refrigerant circuit is activated whereby the system can now meet the increased cooling demands. However, it is expensive to add a separate refrigerant circuit with its attendant components to provide the desired contingency capacity. Additionally, control of capacity is provided by a step increase, not a desired continuous variable increase, and must be carried out by selectively and periodically activating or deactivating one or more refrigerant circuits.

In single refrigerant circuit air conditioning systems having multiple zones, it is known to adjust the cooling capacity of the system in response to the collective demand of the individual zones. U.S. Pat. No. 4,748,822, Erbs et al., discloses an air conditioning system having a single outdoor unit and a single indoor unit providing conditioned air to multiple zones. The system cooling capacity is controlled to meet the collective cooling demand by varying the speed of a variable speed compressor through an inverter controller to control refrigerant flow and to selectively position dampers associated with the respective zones to control air flow to each of the respective zones. In U.S. Pat. Nos. 4,926,652 and 5,245,837, Kitamoto discloses an air conditioning system having a plurality of indoor units connected in a parallel arrangement to the compression device of a single outdoor unit. The compression device includes at least one variable capacity compressor, the capacity of which is controlled to match the collective demand of the indoor units connected to the single outdoor unit. The capacity of the compressor is varied by controlling the speed of the compressor via an inverter electrical circuit.

It would desirable for a multiple circuit refrigerant vapor compression system to have generally continuously variable capacity without the need of selectively activating or deactivating an independent refrigerant circuit.

### SUMMARY OF THE INVENTION

It is a general object of the invention to provide a multiple refrigerant circuit, refrigerant vapor compression system having continuously variable capacity.

In one aspect, it is an object of the invention to provide a multiple circuit, refrigerant vapor compression system having at least one refrigerant circuit including a variable speed compressor.

In another aspect, it is an object of the invention to provide a multiple circuit, refrigerant vapor compression system having at least one economized cycle refrigerant circuit including a variable speed compressor.

A multiple circuit refrigerant vapor compression system includes at least a first refrigerant circuit having a fixed refrigeration capacity and a second refrigerant circuit having a variable refrigeration capacity. Each refrigerant circuits having a compressor, a condenser, an expansion device and an evaporator connected in refrigerant flow communication. The fixed capacity refrigerant circuit includes a fixed capacity compressor and the variable capacity refrigerant circuit includes a variable capacity compressor, which may be a variable speed compressor. A variable speed drive may be provided in operative association with the variable speed compressor for controlling the speed of the variable speed compressor. Other options may include, but are not limited to, a gear-driven or a belt-driven compressor.

A controller may be provided in operative association with the variable speed drive for controlling the variable speed drive to vary the speed of the variable speed compressor to adjust the refrigeration capacity of the variable capacity refrigerant circuit and thereby adjust the overall refrigeration capacity of the system to match the cooling demand. The evaporator of each of the first refrigerant and the second refrigerant circuit may be disposed within a common climate controlled space for conditioning air with the climate controlled space.

An economizer feature may be provided in operative association with the variable capacity refrigerant circuit. The economizer feature includes a first refrigerant passage and a second refrigerant passage. A first portion of refrigerant passes from the outlet of the condenser through a first refrigerant passage in heat exchange relationship with a second portion of refrigerant from the outlet of the condenser passing through the second refrigerant passage. A bypass unloader option may be associated with the economizer feature and variable capacity refrigerant circuit as well.

### BRIEF DESCRIPTION OF THE DRAWINGS

For a further understanding of these and other objects of the invention, reference will be made to the following detailed description of the invention which is to be read in connection with the accompanying drawings, where:

FIG. 1 is a schematic diagram illustrating an exemplary embodiment of a multiple circuit, refrigerant vapor compression system of the invention for conditioning air; and

FIG. 2 is a graphical representation of the variable capacity characteristic of the refrigerant vapor compression system of FIG. 1.

### DETAILED DESCRIPTION OF THE INVENTION

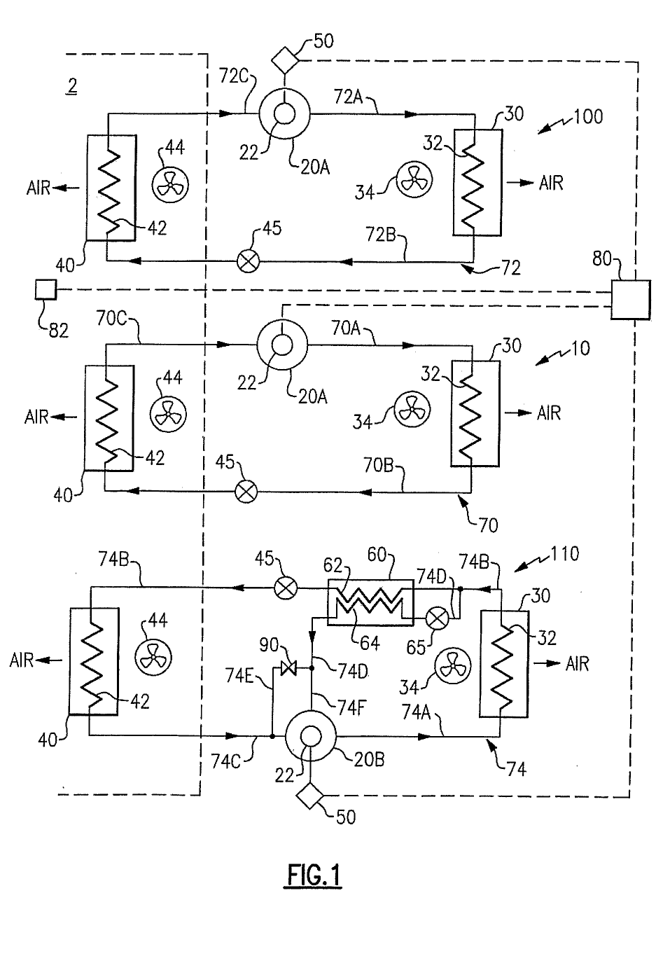

The refrigerant vapor compression system of the invention, as in the exemplary embodiment in FIG. 1, includes three separate refrigerant circuits 10, 100 and 110, each of which operates independently of the other refrigerant circuits under the direction of a system controller 80 for conditioning air within a climate-controlled space 2. In the depicted embodiment, the refrigerant circuit 10 is a non-economized, air conditioning refrigerant circuit incorporating a fixed capacity compressor, the refrigerant circuit 100 is a non-economized, air conditioning refrigerant circuit incorporating a variable capacity compressor, and the refrigerant circuit 110 is an economized, air conditioning refrigerant circuit incorporating a variable capacity compressor. Although the refrigerant vapor compression system of the invention will be described herein with respect to an air conditioning cycle for cooling air, and generally dehumidifying air, it is to be understood that the refrigerant vapor compression system of the invention may also be used in connection with multiple refrigerant circuits arranged in a conventional heat pump cycle for selectively either heating or cooling air. Further, the benefits of the invention can also be utilized in the refrigeration and chiller applications. Various refrigerants, including but not limited to R410A, R407C, R22, R744, and other refrigerants, may be used in the refrigerant vapor compression systems of the invention.

The refrigerant circuit 10 includes a fixed speed, fixed capacity compressor 20A, a condenser 30, an evaporator 40, an expansion device 45, illustrated as a valve, operatively associated with the evaporator 40, and various refrigerant lines 70A, 70B and 70C connecting the aforementioned components in a refrigerant circuit 70 according to a conventional refrigerant vapor compression cycle. The compressor 20A functions to compress and circulate refrigerant through the refrigerant circuit 10 in the conventional manner. The compressor 20A may be a scroll compressor, a screw compressor, a reciprocating compressor, a rotary compressor or any other type of compressor.

The condenser 30, which is disposed externally of the climate-controlled space 2, is a refrigerant condensing heat exchanger having a refrigerant passage 32 connected in flow communication with lines 70A and 70B of the refrigerant circuit 70, through which hot, high pressure refrigerant passes in heat exchange relationship with ambient air passed through the condenser by the condenser fan 34, whereby the refrigerant is desuperheated, condensed and typically subcooled while heating the air. The refrigerant pass 32 of the refrigerant condensing heat exchanger 30, which may be of a conventional tube type or a minichannel tube type, receives the hot, high pressure refrigerant from the discharge outlet port of the compressor 20A through the refrigerant line 70A, desuperheats, condensers and typically subcools this refrigerant in a heat transfer interaction with the ambient air, and returns it to the refrigerant line 70B. It has to be noted that the condensation process described above is generally taking place for subcritical condenser operation, when refrigerant gradually transitions from a vapor phase to a liquid phase. Although for supercritical (above the critical point) region general operation of the heat exchanger 30 is similar, the refrigerant wouldn't change phases but instead would gradually reduce temperature while moving along the passage 32 within the heat exchanger 30. Further, other secondary heat transfer media such as water or glycol solution circulated by a pump (rather than air circulated by a fan) can be utilized for a heat transfer interaction with the refrigerant in the heat exchanger 30.

The evaporator 40, which is disposed within the climate-controlled space 2, is a refrigerant evaporating heat exchanger having a refrigerant passage 42, connected in flow communication with lines 70B and 70C of the refrigerant circuit 70, through which expanded refrigerant passes in a heat exchange relationship with air from the space 2 circulated by an evaporator fan 44 and passed through the evaporator 40, whereby the refrigerant passing through the passage 42 is evaporated and typically superheated. As in conventional refrigerant compression systems, an expansion device 45 is disposed in the refrigerant circuit 70 in line 70B downstream, with respect to refrigerant flow, of the condenser 30 and upstream, with respect to refrigerant flow, of the evaporator 40 for expanding the high pressure refrigerant to a low pressure and temperature before the refrigerant enters the evaporator 40. The refrigerant evaporating heat exchanger coil 42 receives low pressure refrigerant from refrigerant line 70B and returns low pressure refrigerant to refrigerant line 70C to return to the suction port of the compressor 20A. As in conventional refrigerant compression systems, a suction accumulator (not shown) may be disposed in refrigerant line 70C downstream, with respect to refrigerant flow, of the evaporator 40 and upstream, with respect to refrigerant flow, of the compressor 20A to remove and store any liquid refrigerant passing through refrigerant line 70C, thereby ensuring that liquid refrigerant does not enter the suction port of the compression device 20A. As mentioned above, other secondary heat transfer media such as water or glycol solution circulated by a pump (rather than air circulated by a fan) can be utilized for a heat transfer interaction with the refrigerant in the heat exchanger 40 as well.

The refrigerant circuit 100 includes a variable speed, variable capacity compressor 20B, a condenser 30, an evaporator 40, an expansion device 45, illustrated as a valve, operatively associated with the evaporator 40, and various refrigerant lines 72A, 72B and 72C connecting the aforementioned components in a refrigerant circuit 72 according to a conventional refrigerant vapor compression cycle. The compressor 20B functions to compress and circulate refrigerant through the refrigerant circuit 100 in the conventional manner. The variable speed compressor 20B is driven by a conventional variable speed drive 50, which includes a variable speed motor powered by an inverter circuit under the control of the system controller 80. The compressor 20B may be a scroll compressor, a screw compressor, a reciprocating compressor, a rotary compressor or any other type of compressor. Alternatively, the variable capacity compressor may be an adjustable gear-driven compressor or adjustable pulley-driven compressor, wherein the speed of the compressor is controlled in a conventional manner by mechanical means.

The condenser 30, which is disposed externally of the climate-controlled space 2, is a refrigerant condensing heat exchanger having a refrigerant passage 32 connected in flow communication with lines 72A and 72B of the refrigerant circuit 72, through which hot, high pressure refrigerant passes in heat exchange relationship with ambient air passed through the condenser by the condenser fan 34, whereby the refrigerant is desuperheated, condensed and typically subcooled while heating the air. The refrigerant pass 32 of the refrigerant condensing heat exchanger 30, which may be of a conventional tube type or a minichannel tube type, receives the hot, high pressure refrigerant from the discharge outlet port of the compressor 20B through the refrigerant line 72A, desuperheats, condensers and typically subcools this refrigerant in a heat transfer interaction with the ambient air, and returns high pressure, refrigerant to the refrigerant line 72B.

The evaporator 40, which is disposed within the climate-controlled space 2, is a refrigerant evaporating heat exchanger having a refrigerant passage 42, connected in flow communication with lines 72B and 72C of the refrigerant circuit 70, through which expanded refrigerant passes in heat exchange relationship with air from the space 2 circulated by an evaporator fan 44 passed through the evaporator 40, whereby the refrigerant passing through the refrigerant passage 42 is evaporated and typically superheated. As in conventional refrigerant compression systems, an expansion device 45 is disposed in the refrigerant circuit 72 in line 72B downstream, with respect to refrigerant flow, of the condenser 30 and upstream, with respect to refrigerant flow, of the evaporator 40 for expanding the high pressure refrigerant to a low pressure and temperature before the refrigerant enters the evaporator 40. The refrigerant evaporating heat exchanger coil 42 receives low pressure refrigerant from refrigerant line 72B and returns low pressure refrigerant to refrigerant line 72C to return to the suction port of the compressor 20B. As in conventional refrigerant compression systems, a suction accumulator (not shown) may be disposed in refrigerant line 72C downstream, with respect to refrigerant flow, of the evaporator 40 and upstream, with respect to refrigerant flow, of the compressor 20B to remove and store any liquid refrigerant passing through refrigerant line 72C, thereby ensuring that liquid refrigerant does not enter the suction port of the compression device 20B.

The refrigerant circuit 110 includes a variable speed, variable capacity compressor 20B, a condenser 30, an evaporator 40, an expansion device 45, illustrated as a valve, operatively associated with the evaporator 40, an economizer heat exchanger 60, an expansion device 65, illustrated as a valve, operatively associated with the economizer 60, and various refrigerant lines 74A, 74B, 74C, 74D, 74E and 74F connecting the aforementioned components in a refrigerant circuit 74 according to an economized refrigerant vapor compression cycle. The compressor 20B functions to compress and circulate refrigerant through the refrigerant circuit 110 in the conventional manner. The variable speed compressor 20B is driven by a conventional variable speed drive 50 which includes a variable speed motor powered by an inverter circuit under the control of the system controller 80. The compressor 20B may be a scroll compressor, a screw compressor, a reciprocating compressor, a rotary compressor or any other type of compressor. Alternatively, the variable capacity compressor may be an adjustable gear-driven compressor or adjustable pulley-driven compressor, wherein the speed of the compressor is controlled in a conventional manner by mechanical means.

The condenser 30, which is disposed externally of the climate-controlled space 2, is a refrigerant condensing heat exchanger having a refrigerant passage 32 connected in flow communication with lines 74A and 74B of the refrigerant circuit 74, through which hot, high pressure refrigerant passes in heat exchange relationship with ambient air passed through the condenser by the condenser fan 34, whereby the refrigerant is desuperheated, condensed and typically subcooled while heating the air. The refrigerant pass 32 of the refrigerant condensing heat exchanger 30, which may be of a tube type or a minichannel type, receives the hot, high pressure refrigerant from the discharge outlet port of the compressor 20B through the refrigerant line 74A, desuperheats, condensers and typically subcools this refrigerant in a heat transfer interaction with the ambient air, and returns high pressure, refrigerant to the refrigerant line 74B.

In the refrigerant circuit 110, an economizer heat exchanger 60 is disposed in the refrigerant circuit 74 between the condenser 30 and the evaporator 40. The economizer heat exchanger 60 is a refrigerant-to-refrigerant heat exchanger wherein a first portion of refrigerant passes through a first pass 62 of the economizer heat exchanger 60 in heat exchange relationship with a second portion of refrigerant passing through a second pass 64 of the economizer heat exchanger 60. The first flow of refrigerant comprises a major portion of the compressed refrigerant passing through refrigerant line 74B. The second flow of refrigerant comprises a minor portion of the compressed refrigerant passing through refrigerant line 74B.

This minor portion of the refrigerant passes from the refrigerant line 74B into refrigerant line 74D, which communicates with the refrigerant line 74B at a location upstream with respect to refrigerant flow through the economizer heat exchanger 60, as illustrated in FIG. 1. Refrigerant line 74D has an upstream leg connected in refrigerant flow communication between refrigerant line 74B and an inlet to the second pass 64 of the economizer heat exchanger 60 and a downstream leg connected in refrigerant flow communication between an outlet of the second pass 64 of the economizer heat exchanger 60 and the compressor 20B. An economizer expansion device 65 is disposed in refrigerant line 74D upstream of the second pass 64 of the economizer heat exchanger 60 for partially expanding the high pressure refrigerant passing through refrigerant line 74D from refrigerant line 74B to a lower pressure and temperature before the refrigerant passes into the second pass 64 of the economizer heat exchanger 60. As this second flow of partially expanded refrigerant passes through the second pass 64 of the economizer heat exchanger 60 in heat exchange relationship with the first flow of higher temperature, high pressure refrigerant passing through the first pass 62 of the economizer heat exchanger 60, this second flow of refrigerant absorbs heat from the first flow of refrigerant, thereby evaporating and typically superheating while subcooling the first portion of refrigerant. It has to be noted that in an alternate configuration, the economizer expansion device 65 can be positioned downstream of the economizer heat exchanger 60 with respect to the second flow of refrigerant. This alternate configuration would operate generally similar to the refrigerant circuit 110 depicted in FIG. 1.

This second flow of refrigerant passes from the second pass 64 of the economizer heat exchanger 60 through the downstream leg of the refrigerant line 74D to return to the compressor 20B at an intermediate pressure state in the compression process via refrigerant line 74F, for example, by way of illustration and not limitation, through an injection port opening at an intermediate pressure state into the compression chambers of the compressor. Alternately, the refrigerant line 74F can be selectively connected to the suction line 74C through a bypass refrigerant line 74E via opening a flow control device such as bypass valve 90 operatively disposed in the line 74E. In the normal economized mode of operation, the valve 90 is closed and the refrigerant having traversed the second pass 64 of the economizer heat exchanger 60 passes through refrigerant lines 74D and 74F to be injected into the compression chamber of the compressor 20B as hereinbefore described. When the bypass valve 90 is open, a portion of the refrigerant partially compressed in the compressor 20B is redirected, through the lines 74F and 74E, to the suction line 74C to subsequently reenter the compressor 20B through the suction inlet port, rather than being fully compressed and delivered to the discharge outlet port of the of the compressor 20B. In such unload mode of operation, the auxiliary expansion device 65 is preferably closed. In case the auxiliary expansion device is not equipped with shutoff functionality, an additional flow control device is placed in the economizer refrigerant line 74D.

The evaporator 40, which is disposed within the climate-controlled space 2, is a refrigerant evaporating heat exchanger having a refrigerant passage 42, connected in flow communication with lines 74B and 74C of the refrigerant circuit 74, through which expanded refrigerant passes in heat exchange relationship with air from the space 2 circulated by an evaporator fan 44 passed through the evaporator 40, whereby the refrigerant passing through the refrigerant passage 42 is evaporated and typically superheated. As in conventional refrigerant compression systems, an expansion device 45 is disposed in the refrigerant circuit 74 in line 74B downstream, with respect to refrigerant flow, of the economizer heat exchanger 60 and upstream, with respect to refrigerant flow, of the evaporator 40 for expanding the high pressure refrigerant to a low pressure and temperature before the refrigerant enters the evaporator 40. The refrigerant evaporating heat exchanger coil 42 receives low pressure refrigerant from refrigerant line 74B and returns low pressure refrigerant to refrigerant line 74C to return to the suction port of the compressor 20B. As in conventional refrigerant compression systems, a suction accumulator (not shown) may be disposed in refrigerant line 74C downstream, with respect to refrigerant flow, of the evaporator 40 and upstream, with respect to refrigerant flow, of the compressor 20B to remove and store any liquid refrigerant passing through refrigerant line 74C, thereby ensuring that liquid refrigerant does not enter the suction port of the compression device 20B.

In the general descriptions of the refrigerant circuits 10, 100 and 110 presented herein, the condensation process has been described as taking place under subcritical conditions in the condenser 30, wherein the refrigerant gradually transitions from a vapor phase to a liquid phase. It is to be understood by those having ordinary skill in the art that the condenser 30 may be operated under supercritical conditions for certain refrigerants in a similar manner as described hereinbefore. However, under supercritical condenser operation, the refrigerant will not change phase, but instead gradually reduce temperature while passing through the condenser 30. Further, rather than passing air through the condenser 30 to cool the refrigerant, other cooling fluids, such as, for example, water or glycol solution, may be circulated by a pump through the condenser 30 in a heat exchange relationship with the refrigerant. Similarly, other secondary heat transfer fluids, such as, for example, water or glycol solution, may be circulated by a pump through the evaporator 40 in a heat exchange relationship with the refrigerant.

In the refrigerant vapor compression system of the invention, the refrigeration capacity of the system can be adjusted by the controller 80 in response to a change in the cooling demands within the climate-controlled space 2 or a change in the environmental conditions. As the refrigerant circuit 10 is equipped with a fixed speed compressor 20A, the refrigeration capacity of the refrigerant circuit is also fixed at its design capacity. However, since both the refrigerant circuit 100 and refrigerant circuit 110 are equipped with variable capacity compressors, the capacity of each of the refrigerant circuits 100 and 110 may be selectively varied over a relatively wide range, the magnitude of that range being dependent upon the design of the compressor 20B. Further, the refrigerant circuit 110 is equipped with an economizer circuit and a compressor unloader circuit and, therefore, has a variable capacity that may be fine tuned in comparison to the variable capacity refrigerant circuit 100.

In response to an increase in cooling demands, for example, as indicated by a signal received from a thermostat and/or a humidistat 82 indicative of the temperature and/or humidity within the climate-controlled space 2, the controller 80 will adjust the capacity of either or both of the variable capacity refrigerant circuits 100 and 110 to match the collective capacity of the refrigerant circuits 10, 100 and 110 to the current demands. To adjust the capacity of either of the compressors 20B, the controller 80 varies the frequency of the current supplied to the variable speed motor by the variable speed drive 50 operatively associated with the compressor through an inverter circuit in a conventional manner well known to those skilled in the art. Alternatively, if the variable capacity compressor 20B is equipped with an adjustable gear drive or adjustable pulley drive, the speed of the compressor is altered by the mechanical means, as also known in the art.

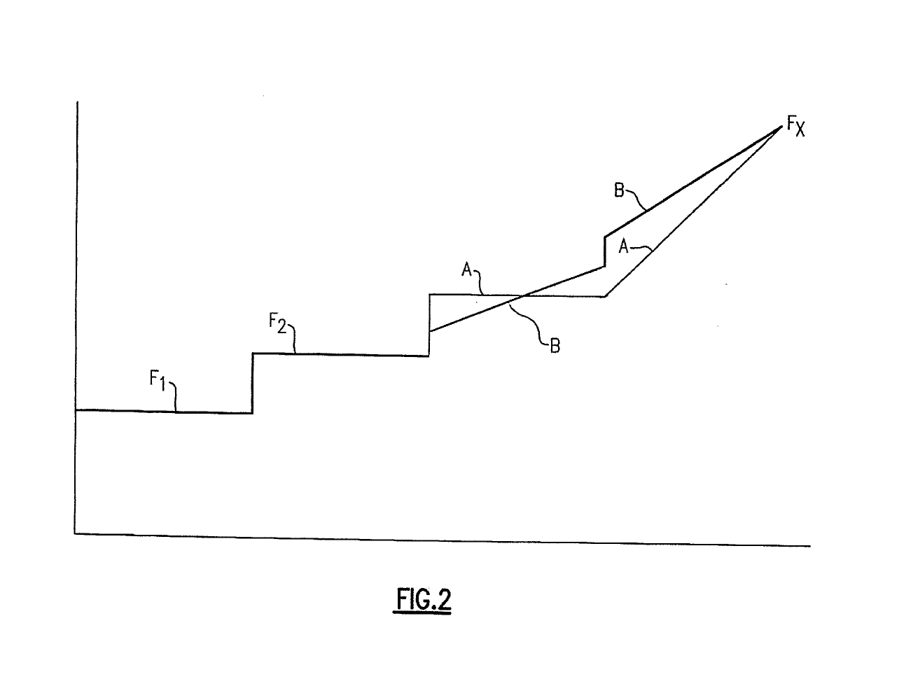

In the refrigerant vapor compression system of the present invention, the capacity of the refrigerant vapor compression system of the invention may be adjusted to any capacity value between a minimum capacity and a maximum capacity by selectively operating the fixed capacity refrigerant circuits and the variable capacity refrigerant circuits to match the present load demands. A fixed capacity refrigerant circuit may be brought on line to provide a step-wise increase in system capacity, while a variable capacity refrigerant circuit may be brought on line to provide an adjustable continuous increase in system capacity. Also, various available capacity enhancement features, such as an economizer cycle, or unloading options, such as a refrigerant bypass, may be utilized in combination with the variable speed capability to further improve flexibility in control and operation. For example, in the system depicted in FIG. 1, the capacity of the refrigerant system may be varied, as illustrated in FIG. 2, from a minimum capacity equal to the design capacity of the non-economized, fixed capacity compressor refrigerant circuit 10, F₁, to a first intermediate capacity, F₂, equal to the design capacity of the refrigerant circuit 10 plus the minimum capacity of either of the variable capacity refrigerant circuits 100, 110, to a maximum capacity, F_{X}, equal to the design capacity of the fixed capacity refrigerant circuit 10, plus the full load capacity of the non-economized variable capacity refrigerant circuit 100, plus the full load capacity of the economized variable capacity refrigerant circuit 110 operating in the economized mode with the bypass valve 90 closed.

Between the first intermediate capacity, F₂, and the maximum system capacity, F_{X}, the controller 80 may vary the overall capacity of the system by selectively increasing the speed of the compressor 20B of the first variable capacity refrigerant circuit brought on line and/or selectively bringing the second variable capacity refrigerant circuit on line and selectively increasing the speed of its compressor 20B to selectively increase the capacity of that refrigerant circuit. For example, if the second variable speed refrigerant circuit is brought on line at minimum capacity (with no bypass unloading and an economizer circuit activated) while the first variable capacity refrigerant circuit remains at minimum capacity, and thereafter the controller 80 selectively increases the speed of the compressors 20A and 20B of the respective variable capacity refrigerant circuits to their fall capacities, as indicated by trace A in FIG. 2, the maximum system capacity F_{X} is achieved. Alternately, the controller 80 could bring the first variable capacity refrigerant circuit to its full capacity before bringing the second variable capacity refrigerant circuit on line at its minimum capacity and thereafter increasing its capacity, as indicated by trace B in FIG. 2. The controller 80 is also capable of fine-tuning of the capacity of the refrigerant vapor compression system by opening the bypass valve 90 to unload the compressor 20B in the refrigerant circuit 110 or selectively opening and closing the economizer expansion device 65 to switch between economized and non-economized operation. Such control logic is depicted by two smaller steps along the trace B in FIG. 2, with the first step associated with closing the bypass valve 90 to load the compressor 20B in the refrigerant circuit 110 and the second step associated with opening the economizer expansion device 65 to switch to the economized operation in the same refrigerant circuit.

It is to be understood that the example of capacity control presented in FIG. 2 is merely illustrative of one way in which capacity may be controlled in the system of the present invention. There are many ways to vary the capacity of the system illustrated in FIG. 1 by selecting which of the refrigerant circuits are operated at any given time. For example, rather than bringing a fixed capacity refrigerant circuit on-line first, a variable capacity circuit could be activated initially and one or more fixed capacity refrigerant circuits and/or additional variable capacity refrigerant circuits subsequently brought on line. Furthermore, at any given time, the controller 80, in order to match load demands, may switch operation from one combination of the refrigerant circuits to another or bring particular circuits on line based on performance (e.g. efficiency) and/or reliability (e.g. a number of start-stop cycles) considerations.

Those skilled in the art will recognize that many variations may be made to the exemplary embodiments described herein. For example, in the refrigerant vapor compression system of the invention depicted in FIG. 1 has three independent refrigerant circuits, including one fixed capacity refrigerant circuit 10, one non-economized, variable capacity refrigerant circuit 100, and one economized, variable capacity refrigerant circuit 110. However, it is to be understood that the system of the present invention may include two or greater number of independent refrigerant circuits including at least one fixed capacity refrigerant circuit and at least one variable capacity refrigerant circuit, whether economized or non-economized. Also, it is to be noted that, although this invention is described in relation to conventional air conditioning systems, the heat pump systems will equally benefit from the teachings of the invention. Furthermore, as known to a person ordinarily skilled in the art, additional advantages such as comfort or humidity control in a conditioned space can be obtained by utilizing the teachings of the invention.

While the present invention has been particularly shown and described with reference to the preferred mode as illustrated in the drawings, it will be understood by one skilled in the art that various changes in detail may be effected therein without departing from the spirit and scope of the invention as defined by the claims.

We claim:

1. A multiple circuit refrigerant vapor compression system comprising:
at least a first refrigerant circuit and a second refrigerant circuit, each of said first and second refrigerant circuits having a compressor, a condenser, an expansion device and an evaporator connected in refrigerant flow communication; characterized in that said first refrigerant circuit has a fixed refrigeration capacity and said second refrigerant circuit has a variable refrigeration capacity.

2. A multiple circuit refrigerant vapor compression system as recited in claim 1 wherein said second refrigerant circuit includes a variable speed compressor.

3. A multiple circuit refrigerant vapor compression system as recited in claim 2 further comprising a variable speed drive operatively associated with said variable speed compressor for controlling the speed of said variable speed compressor.

4. A multiple circuit refrigerant vapor compression system as recited in claim 3 further comprising a controller operatively associated with said variable speed drive for controlling said variable speed drive.

5. A multiple circuit refrigerant vapor compression system as recited in claim 2 wherein said variable speed compressor is a variable speed scroll compressor.

6. A multiple circuit refrigerant vapor compression system as recited in claim 2 wherein said variable speed compressor is a variable speed screw compressor.

7. A multiple circuit refrigerant vapor compression system as recited in claim 2 wherein said variable speed compressor is a variable speed rotary compressor.

8. A multiple circuit refrigerant vapor compression system as recited in claim 2 wherein said variable speed compressor is a variable speed reciprocating compressor.

9. A multiple circuit refrigerant vapor compression system as recited in claim 3 further comprising an inverter circuit operatively associated with said variable speed drive for controlling said variable speed drive.

10. A multiple circuit refrigeration vapor compression system as recited in claim 2 wherein said variable speed compressor includes a mechanical mechanism for controlling the speed of said variable speed compressor.

11. A multiple circuit refrigerant vapor compression system as recited in claim 1 wherein the evaporator of each of said first refrigerant and said second refrigerant circuit is disposed within a climate controlled space for conditioning air within the climate controlled space.

12. A multiple circuit refrigerant vapor compression system as recited in claim 1 further comprising an economizer loop operatively associated with said second refrigerant circuit, said economizer loop including a first refrigerant passage and a second refrigerant passage, the first refrigerant passage for passing a first portion of refrigerant from an outlet of said condenser in heat exchange relationship with a second portion of refrigerant from the outlet of said condenser passing through the second refrigerant passage.

13. A multiple circuit refrigerant vapor compression system as recited in claim 12 wherein said economizer loop of said second refrigerant circuit includes a bypass unloader function.

14. A multiple circuit refrigerant vapor compression system as recited in claim 1 wherein said second refrigerant circuit includes an unloader function.

15. A method of controlling the capacity of a refrigerant vapor compression system comprising the steps of:
providing at least one fixed capacity refrigerant circuit having a fixed capacity compressor, a condenser, an expansion device and an evaporator connected in refrigerant flow communication;
providing at least one variable capacity refrigerant circuit having a variable speed compressor, a condenser, an expansion device and an evaporator connected in refrigerant flow communication; and
selectively bringing on line one or more of said at least one fixed capacity refrigerant circuit and said at least one variable capacity refrigerant circuit.

16. A method as recited in claim 16 further comprising the step of varying the speed of said variable speed compressor to vary the capacity of said variable capacity refrigerant circuit.

17. A method as recited in claim 16 further comprising the step of providing an economizer loop operatively associated with said second refrigerant circuit, said economizer loop including a first refrigerant passage and a second refrigerant passage, the first refrigerant passage for passing a first portion of refrigerant from an outlet of said condenser in heat exchange relationship with a second portion of refrigerant from the outlet of said condenser passing through the second refrigerant passage.

18. A method as recited in claim 17 further comprising the step of providing a bypass unloader function in operative association with the economizer loop of said second refrigerant circuit.

19. A method as recited in claim 16 further comprising the step of providing an unloader function in operative association with said second refrigerant circuit.
